(19) United States
(12) Patent Application Publication
(10) Pub. No.: US 2026/0225117 A1
(43) Pub. Date: Aug. 6, 2026

(54) DEFLECTOR

(71) Applicant: SUNNY BIRD ENTERPRISE CO., LTD., Lukang Township (TW)

(72) Inventor: Cheng-An WANG, Lukang Township (TW)

(21) Appl. No.: 19/047,277

(22) Filed: Feb. 6, 2025

(51) Int. Cl. B05B 3/04; B05B 3/00; B05B 3/02

(52) U.S. Cl. CPC B05B 3/0455; B05B 3/00; B05B 3/02; B05B 3/025; B05B 3/026

(57) ABSTRACT

Disclosed is a deflector for an impact sprinkler. The device has a main body with a rotational base and a connection interface, an angle control device, and a deflector. An oscillating arm is pivotally mounted on the rotational base. The angle control device includes primary and secondary motion stoppers. The deflector has a primary shaft, an axis shaft, a stabilizing arm, an extended lever, and an engagement element. The axis shaft, which is pivotally connected to the rotational base, is connected to the primary shaft, which includes an extension segment engaging a stop surface on the rotational base. The stabilizing arm includes an elastic segment connected to the primary shaft, and a motion restrictor. The extended lever, which is integrally connected to the primary shaft, extends downward to connect the engagement element, which is positioned between the motion stoppers to facilitate a reciprocal motion.

### CROSS-REFERENCE TO RELATED APPLICATIONS

Not applicable.

### FIELD OF THE INVENTION

The present invention relates to components for the construction of impact sprinklers and more particularly to a deflector.

### BACKGROUND OF THE INVENTION

Impact sprinklers equipped with deflectors are widely used to direct water spray within a predefined sector of the surrounding environment.

As shown in FIGS. 1 and 2, a conventional impact sprinkler 01 comprises a main body 11, an angle control device 12, and a direction control device 13. The main body 11 is divided into a rotational base 112 and a connection interface 114. The rotational base 112 supports an oscillating arm 116 in a pivotable manner and includes a water nozzle (not shown). When water from the nozzle strikes on the oscillating arm 116, it causes reciprocal rotation of the oscillating arm 116 relative to the main body 11. The angle control device 12, assembled on the connection interface 114, regulates the angular range of the rotation for the rotational base 112, thereby restricting the watering area of the impact sprinkler 01 to a specific sector. This angle control device 12 incorporates two motion stoppers 122 mounted on the connection interface 114. These motion stoppers 122 define an angular range centered on the connection interface 114, within which the rotational base 112 oscillates. Each motion stopper 122 can rotate independently relative to the connection interface 114, enabling the angular range to be adjusted.

The direction control device 13 is affixed to the main body 11 and selectively interacts with the oscillating arm 116. This device 13 comprises a primary connecting rod 131, a secondary connecting rod 132, and a torsion spring 133. Both the primary connecting rod 131 and the secondary connecting rod 132 are pivotally connected to the main body 11 to allow independent rotation. The torsion spring 133 is provided with two spring arms 134, which are inserted into the primary connecting rod 131 and the secondary connecting rod 132, respectively. This arrangement generates a pulling force between the two connecting rods 131, 132 via the torsion spring 133.

The structural configuration of the direction control device 13 is relatively complicated. The primary connecting rod 131 and the secondary connecting rod 132 are arranged in a nearly overlapping front-to-back orientation relative to the main body 11. In addition, the torsion spring 133 is interposed between these two connecting rods 131 and 132, which increases the complexity of the assembly process. In particular, the torsion spring 133 requires precise installation to ensure effective operation, which adds to the difficulty of securing the rods to the main body 11.

### SUMMARY OF THE INVENTION

The main purpose of the present invention is to introduce a novel deflector. In order to achieve this purpose, the invention employs the following technical solution:

A deflector configured as an integral component of an impact sprinkler device. This sprinkler device comprises a main body, an angle control device, and the deflector. The main body incorporates a rotational base and a connection interface, which are capable of a relative rotational movement, and an oscillating arm is pivotally mounted on the rotational base. The angle control device includes a primary motion stopper and a secondary motion stopper, which are spatially separated and pivotally mounted on the connection interface. These motion stoppers are aligned along a circular path centered on the connection interface and together define a reciprocating rotational angle range for the rotational base.

The deflector is affixed to the rotational base and is designed to rotate independently of the oscillating arm, with the deflector positioned below the oscillating arm.

The deflector comprises a primary shaft, an axis shaft, a stabilizing arm, an extended lever, and an engagement element. One end of the axis shaft is connected to the proximal end of the primary shaft, with the axis shaft pivotally connected to the rotational base along its longitudinal axis. This configuration enables the primary shaft to perform reciprocal rotational motions centered around the axis shaft. At the end proximate to the axis shaft, the primary shaft extends outward to form an extension segment designed to engage a stop surface on the rotational base to ensure positional stability.

The stabilizing arm is positioned above the primary shaft, with one end proximate to the axis shaft incorporating an elastic segment integrally connected to the primary shaft. This arm extends upward to form a motion restrictor which acts as a unidirectional movement limiter for the oscillating arm.

One end of the extended lever is integrally connected to the lower edge of the primary shaft, with its free end extending downward and connecting to the engagement element. The engagement element is located between the primary and secondary motion stoppers, which are aligned along the circular path centered on the connection interface. This arrangement allows the engagement element to alternately engage the primary or secondary motion stopper, restricting its movement and consequently driving the primary shaft in a reciprocating motion.

The integrated construction of the primary shaft, the axis shaft, the stabilizing arm, and the extended lever, combined with the incorporation of the resilient segment, optimizes the structural efficiency of the deflector. This design not only reduces complexity but also enhances the ease of installation onto the rotational base.

### BRIEF DESCRIPTION OF DRAWINGS

FIG. 1 shows a front view of a conventional impact sprinkler.

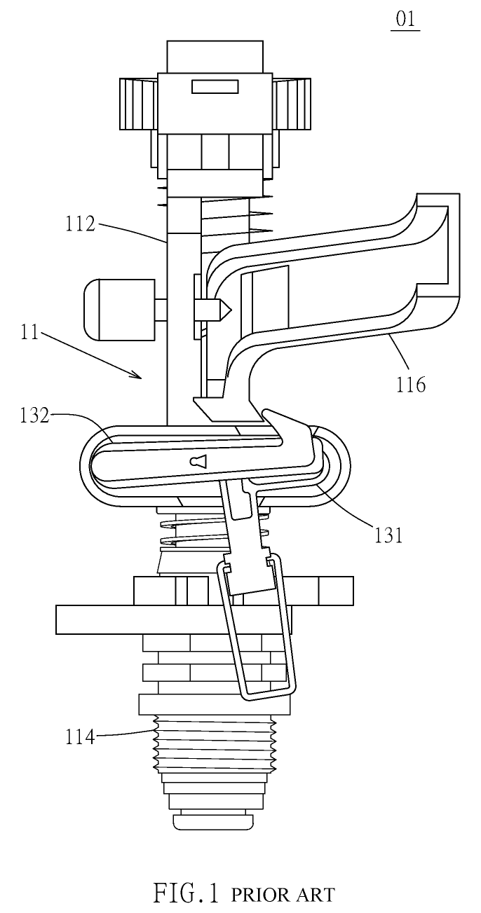

FIG. 2 shows a partial exploded perspective view of the conventional impact sprinkler.

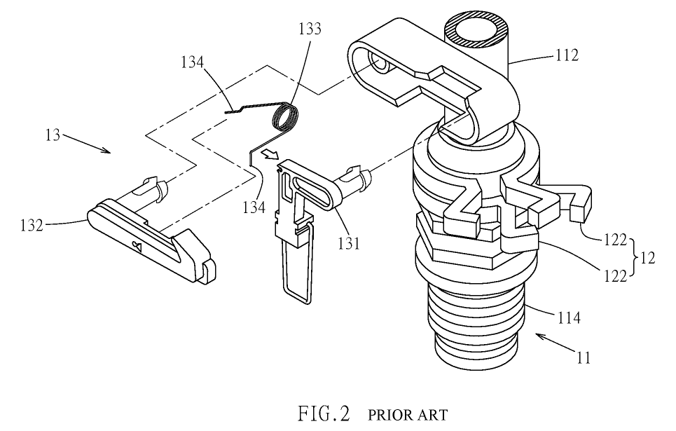

FIG. 3 shows a perspective view of an impact sprinkler with a preferred embodiment of the present invention.

FIG. 4 shows a partial exploded perspective view of the preferred embodiment of the present invention.

FIG. 5 shows a front view of the preferred embodiment of the present invention.

FIG. 6 shows an enlarged partial view of FIG. 5.

FIG. 7 shows a further enlarged partial view of FIG. 6.

FIG. 8 shows an enlarged sectional view taken along line 8-8 in FIG. 7.

FIG. 9 shows a schematic operational state diagram (I) of the preferred embodiment of the present invention.

FIG. 10 shows a schematic operational state diagram (II) of the preferred embodiment of the present invention.

FIG. 11 shows a schematic operational state diagram (III) of the preferred embodiment of the present invention.

### DETAILED DESCRIPTION OF THE INVENTION

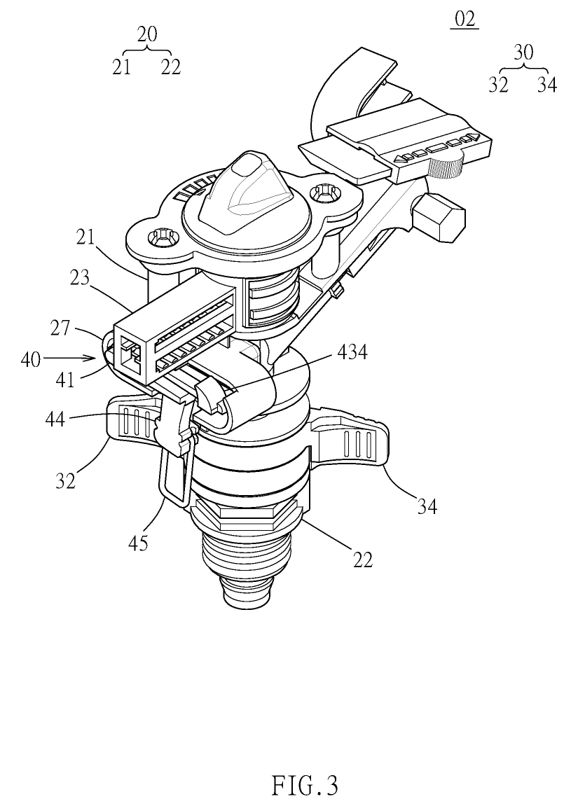

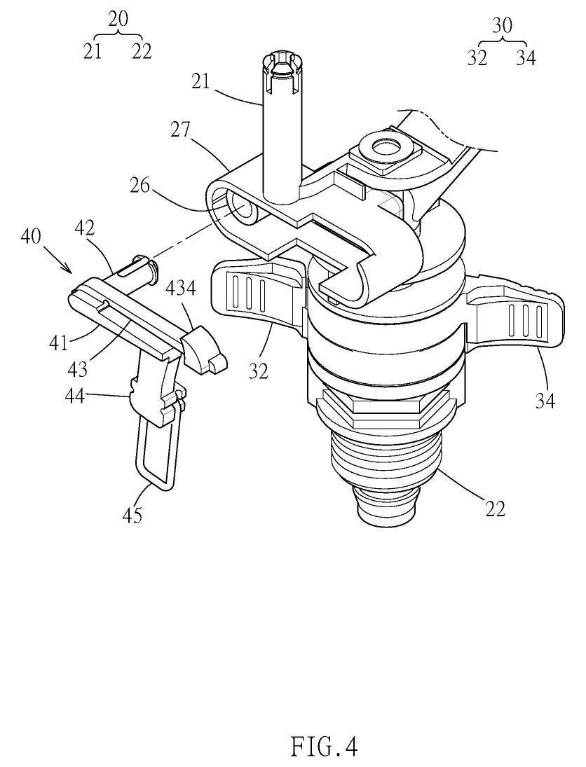

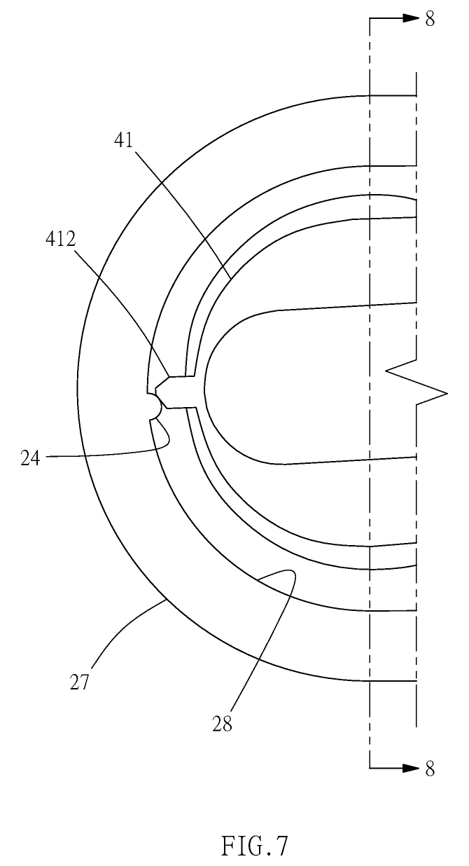

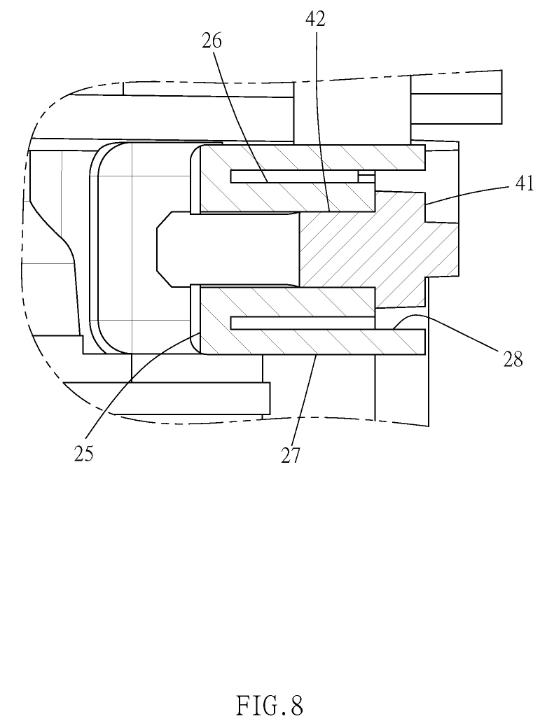

FIGS. 3 to 11 illustrate a preferred embodiment of the deflector proposed in the present invention. However, this embodiment is for illustrative purposes only and should not be construed as limiting the scope of the claims.

Referring to FIGS. 3 to 8, an impact sprinkler device 02 comprises a main body 20, an angle control device 30, and a deflector 40 configured according to the preferred embodiment. The main body 20 includes a rotational base 21 and a connection interface 22, which are capable of a relative rotational movement. An oscillating arm 23 is pivotally mounted on the rotational base 21. The angle control device 30 incorporates a primary motion stopper 32 and a secondary motion stopper 34, which are spaced apart and pivotally mounted on the connection interface 22. These motion stoppers 32 and 34 are aligned along a circular path centered on the connection interface 22, thereby defining a reciprocating rotational angle range for the rotational base 21. The structural configuration of the main body 20 and the angle control device 30 corresponds to that found in prior art.

The deflector 40 is mounted on the rotational base 21 and is capable of independent rotational movement relative to the oscillating arm 23. The deflector 40 is located below the oscillating arm 23 and interacts with an actuator block 232 extending downward from the oscillating arm 23. During operation, the oscillating arm 23 and the deflector 40 rotate together, with the deflector 40 selectively engaging the actuator block 232 to achieve a synchronized motion.

The deflector 40 comprises a primary shaft 41, an axis shaft 42, a stabilizing arm 43, an extended lever 44, and an engagement element 45. One end of the axis shaft 42 is connected to the proximal end of the primary shaft 41, with the axis shaft 42 pivotally connected to the rotational base 21 along its longitudinal axis. This configuration enables the primary shaft 41 to perform a reciprocal rotational movement centered around the axis shaft 42. At the end proximate to the axis shaft 42, the primary shaft 41 extends outward to form an extension segment 412 designed to engage a stop surface 24 on the rotational base 21. In the absence of external forces, the stop surface 24 acts as a rotational limiter for the extension segment 412, thereby restricting the range of movement of the primary shaft 41.

The stabilizing arm 43 is positioned above the primary shaft 41 and has an end proximate to the axis shaft 42 which incorporates an elastic segment 432 integrally connected to the primary shaft 41. The stabilizing arm 43 extends upward to form a motion restrictor 434. When the motion restrictor 434 aligns with the actuator block 232 along the circular path centered on the rotational base 21, it provides a unidirectional movement limiter for the oscillating arm 23. One end of the extended lever 44 is integrally connected to the lower edge of the primary shaft 41, with its free end extending downward and connecting to the engagement element 45. The engagement element 45 is located between the primary motion stopper 32 and the secondary motion stopper 34 along the circular path centered on the connection interface 22. As the deflector 40 rotates about the rotational base 21, the engagement element 45 alternately engages the primary or secondary motion stopper 32, 34. This range restriction formed by these motion stoppers 32, 34 causes the primary shaft 41 to perform a reciprocal rotational motion about the axis shaft 42.

During the reciprocal rotation of the oscillating arm 23 and the deflector 40, the engagement element 45 engages the primary motion stopper 32, which obstructs its movement and redirects the engagement element 45 toward the secondary motion stopper 34. The force exerted by the primary motion stopper 32 on the engagement element 45 is transmitted through the extended lever 44, causing the primary shaft 41 to drive the stabilizing arm 43 to rotate centered about the axis shaft 42. The elasticity of the material allows the extension segment 412 to move from the upper edge of the stop surface 24, pass over it, and rest against the lower edge of the stop surface 24. This action elevates the motion restrictor 434 into the reciprocating path of the actuator block 232.

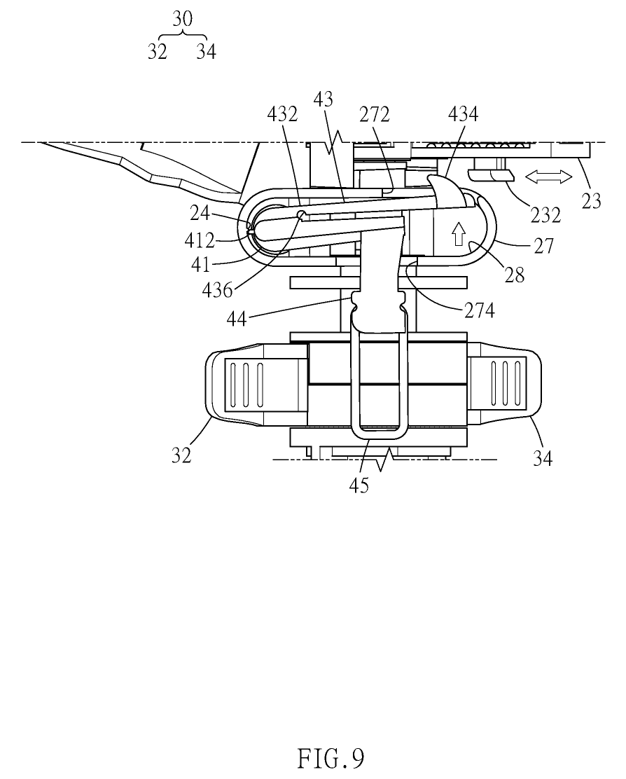

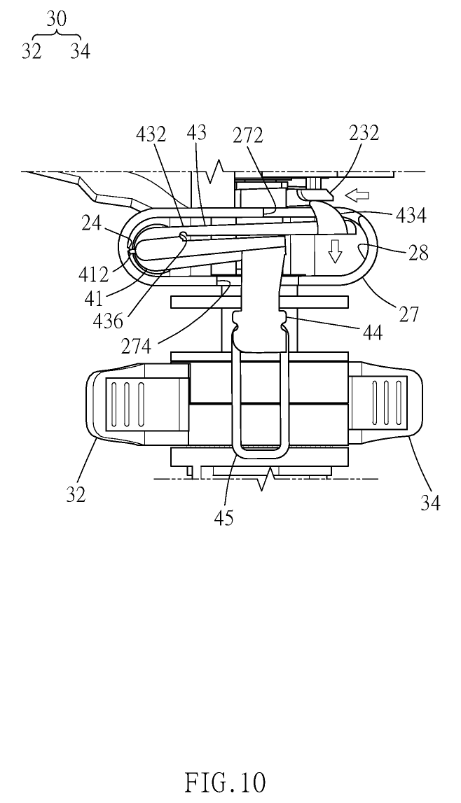

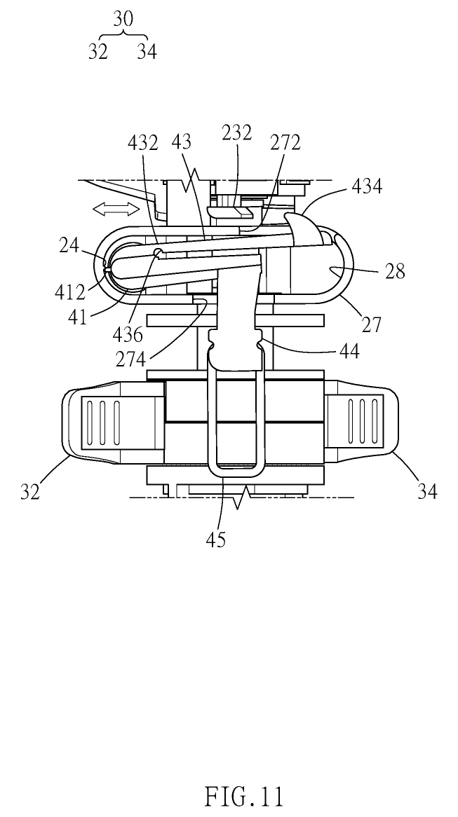

As shown in FIG. 9, the motion restrictor 434 enters the reciprocating path of the actuator block 232 and positions itself to the right of the actuator block 232. In FIG. 10, when the actuator block 232 moves from right to left and contacts the right side of the motion restrictor 434, it forces the motion restrictor 434 downward, enabling the actuator block 232 to pass over its upper edge. FIG. 11 shows that, following the passage of the actuator block 232, the elastic segment 432 restores the stabilizing arm 43 to its original position centered on the elastic segment 432 by an elastic restoring force, and then the motion restrictor 434 re-enters the reciprocating path of the actuator block 232. When the actuator block 232 moves from left to right and contacts the left side of the motion restrictor 434, it acts as a unidirectional movement limiter, stopping further rightward motion and reversing the rotational direction of the oscillating arm 23.

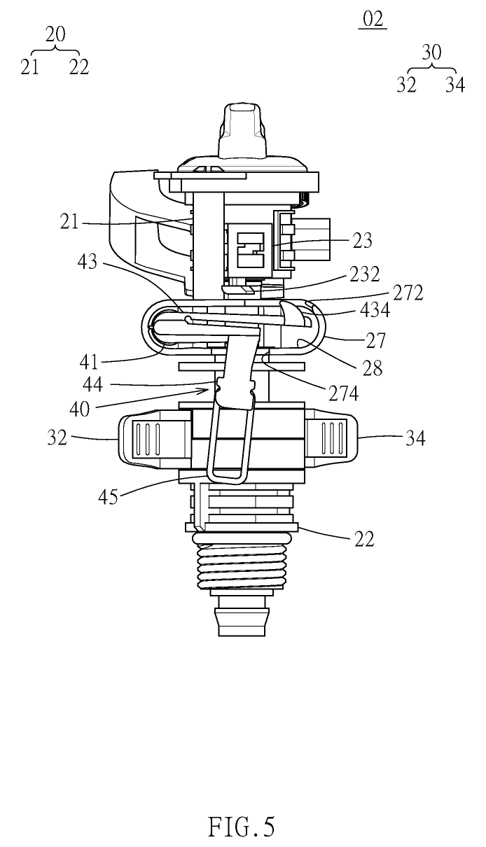

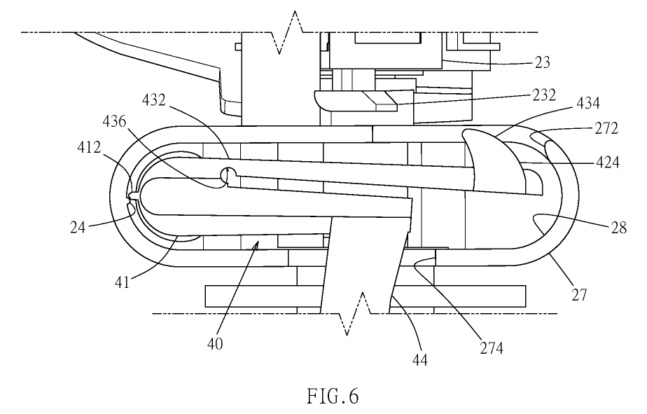

As the rotational base 21 drives the deflector 40 into continuous rotation, the engagement element 45 engages with the secondary motion stopper 34. This engagement forces the coordinated rotation of the engagement element 45, the extended lever 44, the primary shaft 41, and the stabilizing arm 43 centered about the axis shaft 42. At the same time, the extension segment 412 passes from the lower edge of the stop surface 24, crosses it and comes to rest against its upper edge, as the states shown in FIGS. 5 and 6, where the motion restrictor 434 is displaced downward and thereby out of the reciprocating path of the actuator block 232.

The primary shaft 41, the axis shaft 42, the stabilizing arm 43, and the extended lever 44 are integrally formed and couple with the inclusion of the elastic segment 432, the design can completely replace the conventional direction control device 13, which relied on the combination of the primary connecting rod 131, the secondary connecting rod 132, and the torsion spring 133. The streamlined architecture of the deflector 40 simplifies the structural complexity and enhances the ease of installation on the rotational base 21.

The integral construction of the primary shaft 41, the axis shaft 42, the stabilizing arm 43, and the extended lever 44 reduces the spatial occupation compared to the prior art direction control device 13, which utilized the front-to-back overlapping configuration of the primary connecting rod 131 and the secondary connecting rod 132.

The stabilizing arm 43 is also characterized by a recess 436 extending upward from its lower edge. This recess 436 defines the elastic segment 432, which is formed between the upper edge of the stabilizing arm 43 and the recess 436.

The engagement element 45 is pivotally mounted to the extended lever 44, allowing it to rotate independently relative to the extended lever 44. This feature enables the engagement element 45 to selectively engage or disengage with the spatial region defined by the primary motion stopper 32 and the secondary motion stopper 34.

The rotational base 21 incorporates a coupler 25 located below the oscillating arm 23, with the axis shaft 42 pivotally connected to the coupler 25. Specifically, the coupler 25 projects forward to form a pivot joint 26 through which the axis shaft 42 extends axially in a pivotable configuration. The axis shaft 42 forms a tight fit with the pivot joint 26, thereby providing frictional resistance during rotation. This resistance restricts arbitrary rotational movement of the primary shaft 41, thereby increasing the positional stability of the primary shaft 41 beyond the constraints imposed by the stop surface 24.

The rotational base 21 further includes a perimeter wall 27 located below the oscillating arm 23, the perimeter wall 27 extending toward the axis shaft 42 to define the stop surface 24.

The perimeter wall 27 is integrally connected to the coupler 25 and encloses a chamber 28. The primary shaft 41, the stabilizing arm 43, and the stop surface 24 are all housed within this chamber 28.

The upper edge of the perimeter wall 27 is configured with a primary through-hole 272, enabling direct communication between the chamber 28 and the external environment above the perimeter wall 27. This structural feature allows the motion restrictor 434 to selectively protrude through the primary through-hole 272 or to retract into the chamber 28, thereby facilitating controlled engagement or disengagement with the oscillating arm 23. Correspondingly, the lower edge of the perimeter wall 27 incorporates a secondary through-hole 274, which provides communication between the chamber 28 and the external environment below the perimeter wall 27, thereby facilitating the downward extension of the extended lever 44 through the secondary through-hole 274.

The foregoing disclosure and description of the invention is illustrative and explanatory thereof. Various changes in the details of the illustrated construction can be made is the scope of the present invention without departing from the true spirit of the invention. The present invention should only be limited by the following claims and their legal equivalents.

1. A deflector, configured as an integral component of an impact sprinkler device, wherein the impact sprinkler device comprises a main body, an angle control device, and the deflector; the main body including a relatively rotatable rotational base and a connection interface, with an oscillating arm rotatably mounted on the rotational base; the angle control device including a primary motion stopper and a secondary motion stopper, which are spatially separated and pivotally mounted on the connection interface, wherein the primary motion stopper and the secondary motion stopper are aligned along a circular path centered on the connection interface to define a reciprocating rotational angle range for the rotational base; and the deflector affixed to the rotational base and designed to rotate independently of the oscillating arm, with the deflector positioned below the oscillating arm;
the deflector comprising a primary shaft, an axis shaft, a stabilizing arm, an extended lever, and an engagement element, wherein one end of the axis shaft is connected to a proximal end of the primary shaft, the axis shaft being pivotally connected to the rotational base along its longitudinal axis, enabling the primary shaft to perform a reciprocally rotational movement centered around the axis shaft; at the end proximate to the axis shaft, the primary shaft extends outward to form an extension segment designed to engage a stop surface on the rotational base;
the stabilizing arm being positioned above the primary shaft, with one end proximate to the axis shaft incorporating an elastic segment integrally connected to the primary shaft, the stabilizing arm extending upward to form a motion restrictor which acts as a unidirectional movement limiter for the oscillating arm; and
one end of the extended lever integrally connected to the lower edge of the primary shaft, with its free end extending downward and connecting to the engagement element, the engagement element being located between the primary motion stopper and the secondary motion stopper along the circular path centered on the connection interface to alternately engage the primary motion stopper or the secondary motion stopper, thereby restricting its movement and consequently driving the primary shaft in a reciprocating motion.

2. The deflector according to claim 1, wherein the rotational base incorporates a coupler located below the oscillating arm, with the axis shaft pivotally connected to the coupler.

3. The deflector according to claim 2, wherein the coupler projects forward to form a pivot joint through which the axis shaft extends axially in a pivotable configuration, and the axis shaft is configured to form a tight fit with the pivot joint.

4. The deflector according to claim 2, wherein the rotational base further includes a perimeter wall located below the oscillating arm, the perimeter wall extending toward the axis shaft to define the stop surface.

5. The deflector according to claim 4, wherein the perimeter wall is integrally connected to the coupler and encloses a chamber, within which the primary shaft, the stabilizing arm, and the stop surface are all housed.

6. The deflector according to claim 5, wherein the upper edge of the perimeter wall defines a primary through-hole that connects the chamber to the external environment above the perimeter wall, allowing the motion restrictor to selectively protrude through the primary through-hole or to retract into the chamber to engage or disengage with the oscillating arm, and wherein the lower edge of the perimeter wall defines a secondary through-hole that connects the chamber to the external environment below the perimeter wall, facilitating the downward extension of the extended lever through the secondary through-hole.
